(19) United States
(12) Patent Application Publication
(10) Pub. No.: US 2017/0094229 A1
(43) Pub. Date: Mar. 30, 2017

(54) CELL PHONE TOWER FRAUD PREVENTION SYSTEM AND METHOD

(71) Applicants: Mounib Fares Aoun, Raleigh, NC (US); Robert Ezzat Semaan, Miami, FL (US)

(72) Inventors: Mounib Fares Aoun, Raleigh, NC (US); Robert Ezzat Semaan, Miami, FL (US)

(21) Appl. No.: 14/870,082

(22) Filed: Sep. 30, 2015

(51) Int. Cl. H04N 7/18

(52) U.S. Cl. CPC H04N 7/183

(57) ABSTRACT

The invention relates to a system and method for determining the presence of unauthorized communications equipment on an elevated structure, such as a cell phone tower, by electronically monitoring the number of electronic cables on the elevated structure.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

Field of the Invention

The present invention relates to a method and system for the prevention of fraudulent placement of equipment on an elevated structure used for antennae and electronic communications equipment.

Description of Related Art

The advent of cell phone companies was accompanied by each cell phone company placing their equipment on towers, or other elevated structures, individually owned or leased by each of the cell phone companies. By the late 1990's it became apparent that there were too many of these elevated structures. Regulation and practicality necessitated that the ownership of these elevated structures, especially cell phone towers, move to companies other than the cell phone companies themselves, in order for each structure to share equipment from two or more cell phone companies.

There are well over 200,000 elevated structures in the US used for such purposes. Individual owners of towers may own 20,000 or more such structures, which makes monitoring each individual structure by physically visiting them all difficult or impossible. Worldwide estimates for cell towers state that there are as many as four million towers being used for cell equipment only already in existence, with possibly as many as another two million elevated structures being utilized for these same purposes.

With so many towers, and many of them being shared, a new problem has recently arisen. Companies, individuals, and, in some countries, terrorist groups, have taken to placing communications equipment on these structures without the owner's knowledge, and obviously without authorization or paying any leasing fees. The cost of leasing space on these structures has continued to rise, with $250,000 per year leases common in some places.

Because of the large number of these elevated structures, their distance apart makes visiting them impractical, since it would take too much time to visit each structure and the cost to visit each structure and inspect it would be more than any licensing fees one could currently make on each structure. With each site having multiple pieces of equipment on it, it has become difficult, if not impossible, to determine if a piece of equipment on a given tower has fraudulently been placed on the cell tower or other elevated structure. Over the last few years, tens of millions of leasing fees have been lost annually with no solution available, other than randomly catching the unauthorized activity.

### BRIEF SUMMARY OF THE INVENTION

The present invention relates to a method of continually monitoring a plurality of communication elevated structures for unauthorized placement of equipment by monitoring the amount of equipment on the structures. But specifically, in this invention, instead of monitoring the equipment itself, a more practical system is provided by electronically monitoring the cables running from equipment to the bottom of the elevated structure, where the cables are connected to a communication junction or other type of device.

Accordingly, in one embodiment of the invention, there is a method for monitoring a plurality of elevated structures, used for the placement of communications equipment having cables, for the unauthorized placement of equipment with cables on the structures comprising:
a) electronically monitoring the communication equipment cables on each elevated structure over time;
b) transferring the electronic monitoring of the cables to a computer; and
c) the computer comparing the monitoring of the cables on each structure over time for changes in the cables related to the quantity of equipment on the elevated structure.

In yet another embodiment of the invention, there is a system for monitoring a plurality of elevated structures, used for the placement of communications equipment having cables, for the unauthorized placement of equipment on the structures comprising:
a) a device for electronically monitoring the cables on each structure;
b) a device for transferring the monitoring of the cables to a computer; and
c) a computer, having software programmed for comparing the monitoring of the cables on each structure over time for changes in the cables related to the quantity of equipment on the elevated structure.

### BRIEF DESCRIPTION OF THE DRAWINGS

FIG. 1 is a view of an elevated structure (cell tower) with transmitters, antennae and cables.

FIG. 2a and FIG. 2b are a first embodiment of a camera, detecting an increase in elevated structure cables.

FIG. 3 is a second embodiment of a camera, measuring the electromagnetic field given off by communication equipment on an elevated structure.

FIG. 4 is a relationship diagram of the system of the present invention.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The word “term” refers to either a single word or a phrase.

The terms “about” and “essentially” mean±10 percent.

The terms “a” or “an”, as used herein, are defined as one or as more than one.

The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “communications equipment having cables” refers to antennae and communications equipment, i.e. transmitters, receivers, transceivers, digital signal processors, control electronics, GPS equipment and the like. Such cell phone equipment is placed on an elevated structure and has an electronic cable running down the elevated structure for transferring the electronic communications signal to another location.

As used herein, the term “elevated structures” refers to a high place where communications equipment is placed to give transmitting/receiving equipment the greatest sight line (greatest distance) for sending and receiving a signal, such as a cell phone signal. They can be tall buildings, naturally tall places (e.g. hills and mountains), but, for the most part, the elevated structure will be a constructed tower which supports the equipment at the top or along the tower's length. These stations are typically called cell phone masts or base stations. Examples of such towers are monopole towers, lattice towers, guyed towers, concealed and stealth towers, and broadcast towers. This list is not complete and other types of elevated structures are used in the industry of communications transmission and receipt.

As used herein, the term “unauthorized placement” refers to the fact that most elevated structures are owned by an organization other than the organization placing the equipment. They lease the space on their elevated structure to various companies (even those elevated structures owned by communication companies actually lease space too) and lease their tower space to various companies to place their equipment. The unauthorized placement refers to placement of communication equipment having cables on an elevated structure which either is not owned by the placer, or that the placer does not have permission from the owner of the tower (either by failure to lease or failure to pay agreed lease fees).

As used herein, the term “electronically monitoring” refers to the fact that each piece of authorized equipment will have cables running down the elevated structure and then those number of cables becomes a baseline for the authorized equipment on the elevated structure. Any increase in the number of cables on the elevated structure will mean that a piece of equipment has been added to the elevated structure. That added equipment is either authorized or not. If the owner of the tower determines that this new piece of equipment is unauthorized on the tower, then the equipment can be removed or charged a fee for remaining. By taking readings of the cables over time, the successive readings can be compared, and changes in the comparisons can be determined to be from additional equipment or not. For example, one or more video recorders, scanners, or cameras can take successive pictures, images, or the like, of a small portion of the cables that, together, show all the cables on the elevated structure. They can be placed at the upper, middle or lower portion of the tower, or the distribution box, or wherever is best for the individual towers. A computer can compare these successive pictures or images and determine if the cables have moved or if there are an increased number of cables. Software in the computer can store the result of the monitoring and determine, by comparison, the increase in the number of cables, indicating equipment has likely been placed on the elevated structure. The structure can then be checked for additional equipment, or the owner of the tower can confirm authorized placement of new equipment on the tower.

Another example would be to gather the cables together and monitor the electromagnetic radiation from a selected point for all the cables. The radiation will increase and decrease with use, but stay within a range. If the range measured increases, it is likely from an increase in equipment (i.e. more cable(s)) and, once again, the elevated structure can be checked for new unauthorized equipment. It is likely that, once there is a detection, that one might need to check with the owner of the elevated structure to determine if this is authorized or not, since the owner may have neglected to inform the person doing the measurement, but one can see if the measurement is positive one doesn't have to visit all of their cell towers

As used herein, the term “over time” refers to taking repeated measurements, such that a baseline is taken initially with authorized equipment, and continuously or intermittently measuring the status of the cables as time passes. For example, an electronic picture could be taken once a day and compared to the baseline picture by a computer. In another example, the electromagnetic field generated by the cables could be monitored continuously over time to determine a high and low range of the field, and then determine when the measurement is large enough to indicate the presence of a new cable.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein. The computer will have thereon software and firmware designed in computer readable memory to compare the results over time of the monitoring and determine if there are changes which indicate an increase in the number of cables on the elevated structure, thus indicating an increase in equipment on the elevated structure.

As used herein, the terms “software” and “firmware” are interchangeable, and include any computer program stored in memory for execution by devices that include, without limitation, mobile devices, dusters, personal computers, workstations, clients, and servers.

As used herein, the term “transferring to a computer” refers, not just to transferring data, but also to taking and moving the measurements from the measuring device to a computer by any means, such as wirelessly, wired, by network or any other means. This is for the purpose of taking the measurements and evaluating them for the presence, absence or removal of cables (removal of cables could indicate a theft) and not just for the purpose of transferring the data.

As used herein, the term “remote location” refers to a place other than the elevated structure, for example a single site where a computer is located and all the devices at multiple elevated structures report in. For example, if there were 20,000 elevated structures, each of them could report to a single (remote) location for the purpose of determining if there is unauthorized equipment on any of them.

### DRAWINGS

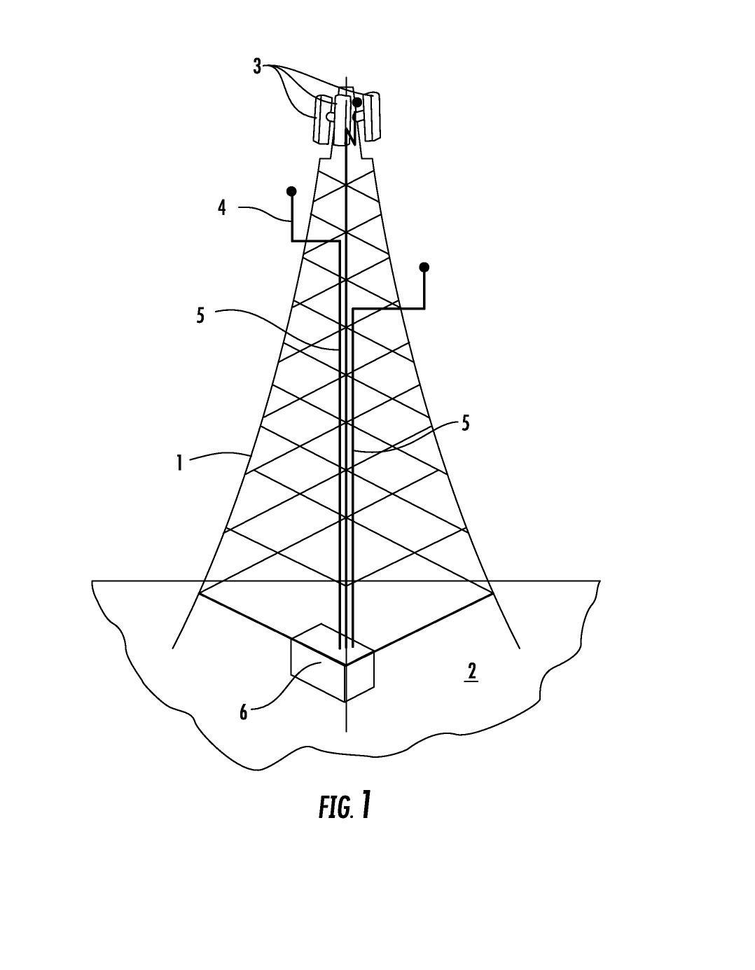

And now referring to the drawings, FIG. 1 is a view of an elevated structure. Elevated structure, cell tower 1, sits on ground 2 and has cell transmitter/receivers 3 and antennae 4 mounted thereon. In this view, each antennae 4 and transmitter/receiver 3 has a cable 5 running down tower 1 for power and cell information down to a junction box 6 for transfer of the communication signal elsewhere.

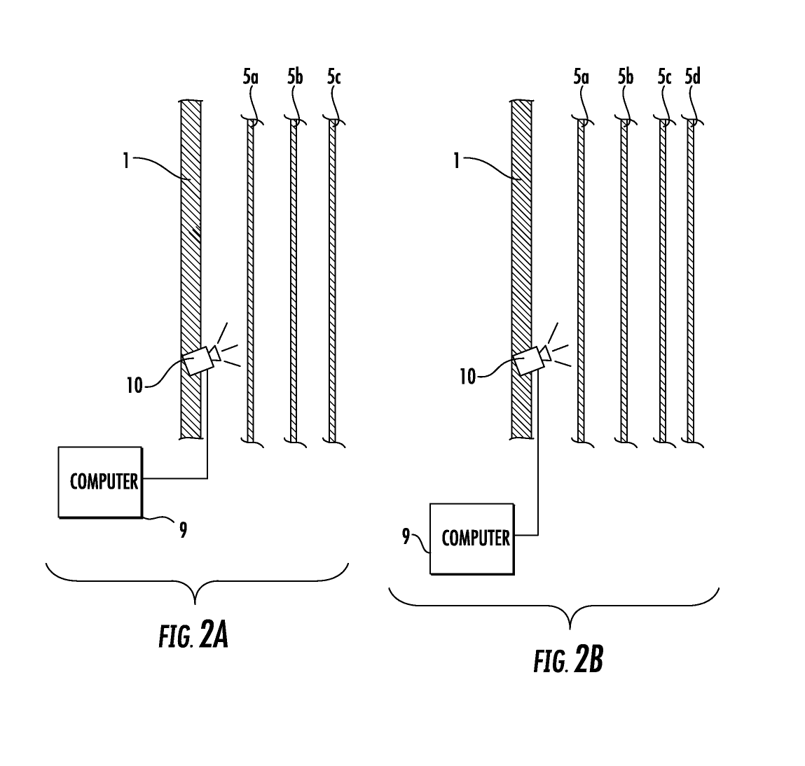

In FIG. 2a there is shown a portion of a cell tower 1 with three cables 5a, 5b and 5c, from three pieces of equipment on the tower 1. A video or still camera 10 is taking movies or still photos, noting that, in this view, all three cables are authorized. In FIG. 2b an unauthorized cable 5d is present on tower 1 and the camera 10 can take a picture/video and send the picture/video to a computer 9 for comparison of the picture in FIG. 2a with the picture in FIG. 2b to determine whether there is a new cable and, thus, new equipment on the elevated structure 1.

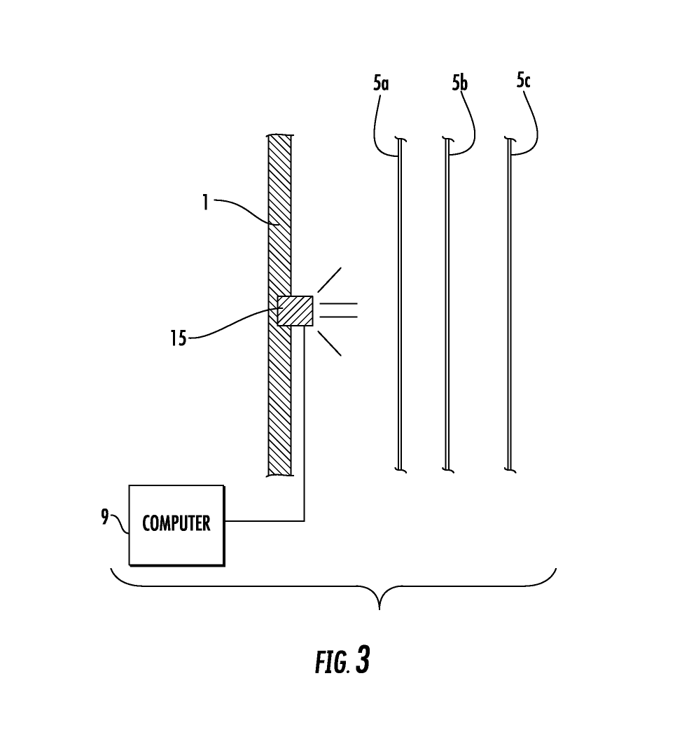

FIG. 3 shows an alternate embodiment of monitoring the cables 5a, 5b and 5c. In this view, a device for monitoring 15 the electromagnetic radiation of cables 5a, 5b and 5c is the monitoring device. In this view, if an additional cable, e.g. 5d, is present, the electromagnetic radiation of the new cable, in combination with the original cables, can be detected and indicate the presence of a new cable, and thus additional equipment, which then it can be determined if it is authorized new equipment or not.

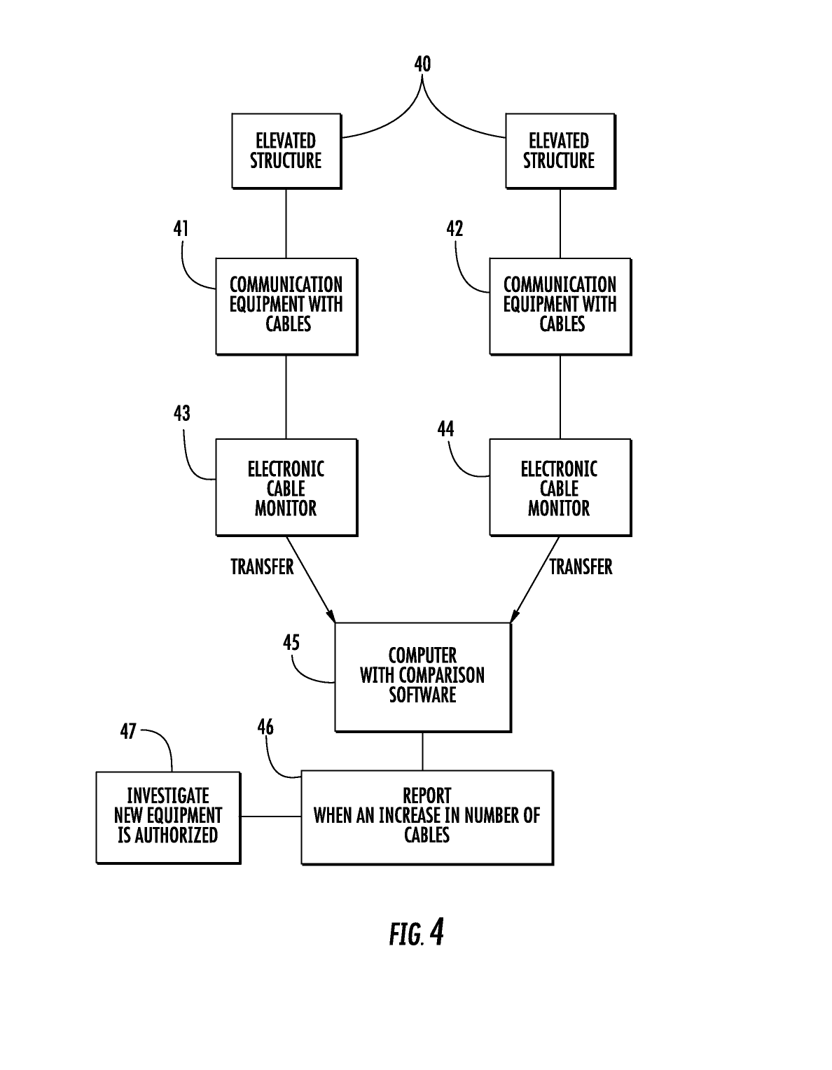

FIG. 4 is a relationship of parts of the system of the present invention. In this view, multiple elevated structures 40 each have communication equipment 41 and 42, each with cables for each of the pieces of equipment. Each of the cables on each elevated structure 40 is monitored by an electronic cable monitor 43 and 44 respectively. Each of the cable monitors reports to a computer 45, which has comparison software for comparing the cables on the elevated structures 40 over a period of time, monitoring for changes indicating an increase in the number of cables and thus an increase in the number of pieces of equipment on the tower, which can then be used to determine if the new piece of equipment is authorized or not. The location of computer 45 is as desired, and can be a local or remote location as needed. Much will depend on the number of elevated structures 40 and their exact location in such a determination. Once a comparison has been accomplished, the computer 45 can produce a report 46 for determining if there is new equipment on the elevated structure 40, followed by if there is such new equipment determining if it is authorized or not by further investigation 47.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method for monitoring a plurality of elevated structures, used for the placement of communications equipment having cables, for monitoring the unauthorized placement of equipment with cables on the structures comprising:
a) electronically monitoring the communication equipment cables on each elevated structure over time;
b) transferring the electronic monitoring of the cables to a computer; and
c) the computer comparing the monitoring of the cables on each structure over time for changes in the cables related to the quantity of equipment on the elevated structure.

2. The method according to claim 1 wherein the elevated structure is a cell phone tower.

3. The method according to claim 1 wherein the electronic monitoring comprises taking an electronic photo of the equipment cables repeatedly over time.

4. The method according to claim 1 wherein the electronic monitoring comprises measuring the electronic radiation emitted by the cables over time.

5. The method according to claim 1 wherein the computer is at a remote location.

6. The method according to claim 1 wherein the result of the computer comparison is transferred to the owner of the elevated structure.

7. A system for monitoring a plurality of elevated structures, used for the placement of communications equipment having cables, for monitoring the unauthorized placement of equipment on the structures comprising:
a) a device for electronically monitoring the cables on each structure;
b) a device for transferring the monitoring of the cables to a computer; and
c) a computer having software programmed for comparing the monitoring of the cables on each structure over time for changes in the cables related to the quantity of equipment on the elevated structure.

8. The system according to claim 7 wherein the elevated structure is a cell phone tower.

9. The system according to claim 7 wherein the electronic monitoring comprises a device for taking an electronic photo of the equipment cables repeatedly over time.

10. The system according to claim 7 wherein the electronic monitoring comprises a device for measuring the electronic radiation emitted by the cables over time.

11. The system according to claim 7 wherein the computer is positioned at a remote location.

12. The system according to claim 7 wherein there is a device for transferring the result of the computer comparison to the owner of the elevated structure.
